(19) United States
(12) Patent Application Publication
(10) Pub. No.: US 2013/0027843 A1
(43) Pub. Date: Jan. 31, 2013

(54) MULTI-LAYERED CERAMIC ELECTRONIC COMPONENT

(71) Applicants: Byung Kil SEO, Suwon (KR); Byung Sung KANG, Suwon (KR)

(72) Inventors: Byung Kil SEO, Suwon (KR); Byung Sung KANG, Suwon (KR)

(73) Assignee: Samsung Electro-Mechanics Co., Ltd.

(21) Appl. No.: 13/558,883

(22) Filed: Jul. 26, 2012

(30) Foreign Application Priority Data
Jul. 26, 2011 (KR) 10-2011-0074042

(51) Int. Cl. H01G 4/12

(52) U.S. Cl. 361/321.2

(57) ABSTRACT

There is provided a multi-layered ceramic electronic component including: a ceramic main body including a dielectric layer; and inner electrode layers disposed to face each other, with the dielectric layer interposed therebetween, in the ceramic main body, wherein when an average thickness of the dielectric layer is defined as t_{d}, the average thickness t_{d} is t_{d}≧15 μm, and the number of dielectric grains per 10 μm within the dielectric layer is 15 or greater. Since a uniform, thick dielectric layer can be obtained with fine dielectric powder, a high voltage multi-layered ceramic electronic component having excellent withstand voltage characteristics can be implemented.

### CROSS-REFERENCE TO RELATED APPLICATIONS

This application claims the priority of Korean Patent Application No. 10-2011-0074042 filed on Jul. 26, 2011, in the Korean Intellectual Property Office, the disclosure of which is incorporated herein by reference.

### BACKGROUND OF THE INVENTION

1. Field of the Invention

The present invention relates to a high pressure multi-layered ceramic electronic component having improved withstand voltage characteristics.

2. Description of the Related Art

As electronic products have tended to be reduced in size, multi-layered ceramic electronic components have accordingly been required to be reduced in size and yet have a large capacity.

Thus, efforts have been undertaken to make dielectric and inner electrodes thinner and multi-layered through various methods, and recently, multi-layered ceramic electronic components including an increased number of thinner dielectric layers have been manufactured.

Meanwhile, multi-layered ceramic electronic components used for the purpose of applying a high voltage are required to have high withstand voltage characteristics.

However, when the dielectric layers are formed to be overly thin, they may be broken at a relatively low voltage, making it difficult to apply a high voltage thereto.

Thus, when having high voltage applied thereto, dielectric layers are designed to be thicker to reduce voltage applied per thickness, thus withstanding high voltage.

Also, a printed pattern of inner electrodes is formed to have small overlap portions between inner electrodes, thus reducing voltage applied to the inner dielectric layers.

However, high voltage multi-layered ceramic electronic components having excellent withstand voltage characteristics are still in demand.

### SUMMARY OF THE INVENTION

An aspect of the present invention provides a high pressure multi-layered ceramic electronic component having improved withstand voltage characteristics.

According to an aspect of the present invention, there is provided a multi-layered ceramic electronic component including: a ceramic main body including a dielectric layer; and inner electrode layers disposed to face each other, with the dielectric layer interposed therebetween, in the ceramic main body, wherein when an average thickness of the dielectric layer is defined as t_{d}, the average thickness t_{d} is t_{d}≧15 μm, and the number of dielectric grains per 10 μm within the dielectric layer is 15 or greater.

The inner electrode layers may include first and second inner electrodes each having one ends thereof alternately exposed to respective opposed end surfaces of the ceramic main body.

The inner electrode layers may include: a plurality of first and second inner electrodes each having respective one ends exposed to respective end surfaces in a lengthwise direction of the ceramic main body; and at least one or more floating electrodes forming an overlap area with the first and second inner electrodes, with the dielectric layer interposed therebetween.

When an average particle diameter of the dielectric grains is defined as De, the average particle diameter De may satisfy the condition of De≧0.4 μm, in particular, 0.21 μm≦De≦0.4 μm.

The average thickness of the dielectric layer may be an average thickness of the dielectric layer in the section in a lengthwise and thicknesswise direction taken from a central portion in the widthwise direction of the ceramic main body.

According to another aspect of the present invention, there is provided a multi-layered ceramic electronic component including: a ceramic main body including a plurality of dielectric layers laminated therein; and a plurality of inner electrode layers disposed to face each other, with each of the plurality of dielectric layers interposed therebetween in the ceramic main body, wherein when an average thickness of the dielectric layer is defined as t_{d}, the average thickness t_{d} may be t_{d}≧15 μm, and the number of dielectric grains per 10 μm within the dielectric layer may be 15 or greater.

The inner electrode layers may include first and second inner electrodes each having one ends thereof alternately exposed to respective opposed end surfaces of the ceramic main body.

The inner electrode layers may include: a plurality of first and second inner electrodes having respective one ends exposed to respective end surfaces in a lengthwise direction of the ceramic main body; and at least one or more floating electrodes forming an overlap area with the first and second inner electrodes with the dielectric layer interposed therebetween.

When an average particle diameter of the dielectric grains is defined as De, the average particle diameter De may satisfy the condition of De≦0.4 μm, in particular, 0.21 μm≦De≦0.4 μm.

The average thickness of the dielectric layer may be an average thickness of the dielectric layer at a central portion in the section in a lengthwise and thicknesswise direction taken from the central portion in the widthwise direction of the ceramic main body.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a multi-layered ceramic capacitor according to an embodiment of the present invention;

FIG. 2 is a cross-sectional view taken along line B-B′ in FIG. 1;

FIG. 3 is an enlarged view of area ‘S’ in FIG. 2;

FIG. 4 is a cross-sectional view taken along line B-B′ in FIG. 1 according to another embodiment of the present invention; and

FIG. 5 is an enlarged view of area ‘S’ in FIG. 4.

### DETAILED DESCRIPTION OF THE EMBODIMENT

The invention may be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

Exemplary embodiments of the present invention will now be described in detail with reference to the accompanying drawings.

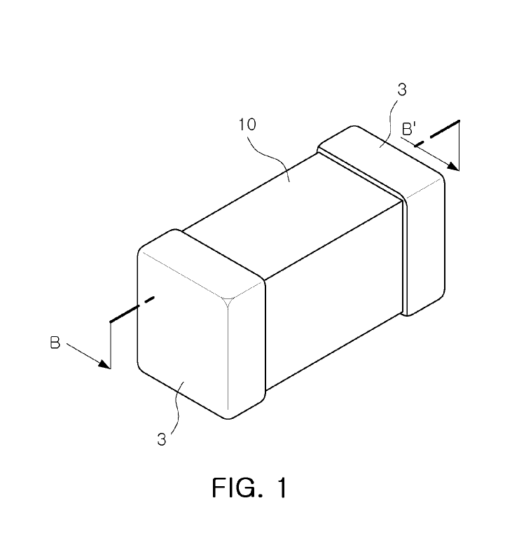

FIG. 1 is a perspective view schematically showing a multi-layered ceramic capacitor according to an embodiment of the present invention.

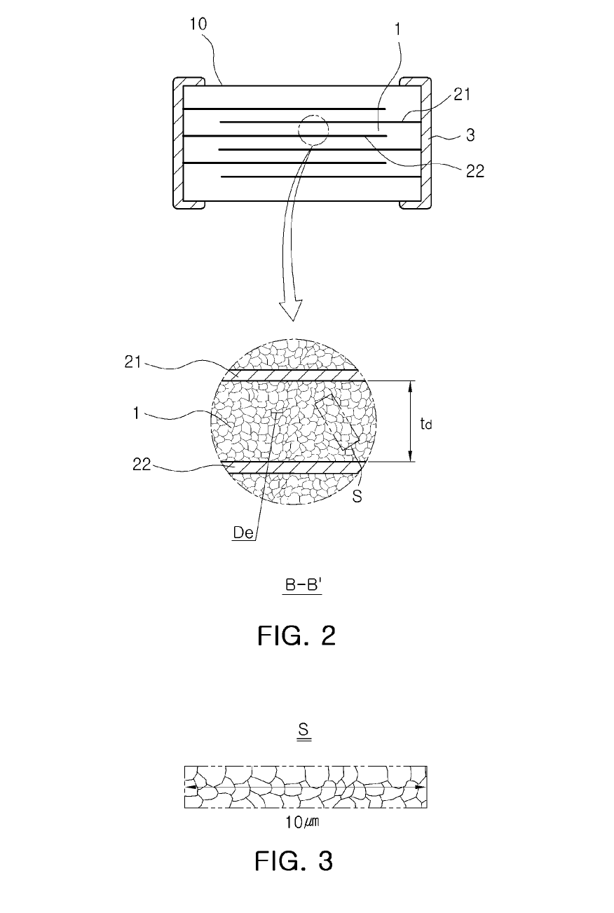

FIG. 2 is a cross-sectional view taken along line B-B′ in FIG. 1, and FIG. 3 is an enlarged view of area ‘S’ in FIG. 2.

With reference to FIGS. 1 and 2, a multi-layered ceramic electronic component according to an embodiment of the present invention may include a ceramic main body 10 including a dielectric layer 1; and inner electrode layers 21 and 22 disposed to face each other, with the dielectric layer 1 interposed therebetween, in the ceramic main body 10, wherein when an average thickness of the dielectric layer 1 is defined as t_{d}, the average thickness t_{d} may be t_{d}≧15 μm, and the number of dielectric grains per 10 μm within the dielectric layer 1 may be 15 or greater.

The inner electrode layers 21 and 22 may include first and second inner electrodes, and one end of each of the inner electrodes may be alternately exposed to the respective opposed end surfaces of the ceramic main body.

Hereinafter, a multi-layered ceramic electronic component, in particular, a multi-layered ceramic capacitor, according to an embodiment of the present invention will be described, but the present invention is not limited thereto.

According to an embodiment of the present invention, a material used for forming the dielectric layer 1 is not particularly limited so long as it can obtain sufficient capacitance. For example, the material may be barium titanate (BaTiO₃) powder.

The material for forming the dielectric layer 1 may be formed by adding various materials such as a ceramic additive, an organic solvent, a plasticizer, a binding agent, a dispersing agent, and the like, to powder such as barium titanate (BaTiO₃) powder, or the like, according to the purpose of the present invention.

The inner electrode layers 21 and 22 are not particularly limited. For example, the inner electrode layers 21 and 22 may be formed by using a conductive paste formed of one or more of silver (Ag), lead (Pb), platinum (Pt), nickel (Ni), and copper (Cu).

In order to form capacitance, outer electrodes 3 may be formed on outer surfaces of the ceramic main body 10 and may be electrically connected to the first and second inner electrodes 21 and 22.

The outer electrodes 3 may be formed of the same conductive material as that of the inner electrodes 21 and 22, and may be formed by using copper (Cu), silver (Ag), nickel (Ni), or the like, but the present invention is not limited thereto.

The outer electrodes 3 may be formed by applying the conductive paste prepared by adding glass frit to the metal powder, and then firing the same.

In the multi-layered ceramic capacitor according to an embodiment of the present invention, an average thickness td of the dielectric layer 1 may be 15 μm or greater.

The average thickness of the dielectric layer 1 may refer to an average thickness of the dielectric layer formed between the adjacent inner electrode layers 21 and 22.

The average thickness td of the dielectric layer 1 may be measured by scanning an image of a dielectric layer section in a lengthwise direction of the ceramic main body 10 by using a scanning electron microscope (SEM) of 10,000× magnification.

In detail, the average value can be measured by measuring the thickness of 30 points (or spots), of one dielectric layer, at an equidistant intervals in the lengthwise direction on the scanned image.

The multi-layered ceramic capacitor according to an embodiment of the present invention is a component for a high voltage, and in order to enhance withstand voltage characteristics by increasing a breakdown voltage (BDV), the average thickness t_{d} of the dielectric layer 1 may be 15 μm or greater.

Here, a high voltage refers to a voltage band, for example, ranging from 1 KV to 5 KV, but the present invention is not limited thereto and the multi-layered ceramic capacitor according to an embodiment of the present invention can also be applicable to a middle voltage ranging from 100 V to 630 V.

If the average thickness td of the dielectric layer 1 is lower than 15 μm, the breakdown voltage may be lowered over the high voltage applied to the multi-layered ceramic electronic component.

With reference to FIGS. 2 and 3, in the multi-layered ceramic capacitor according to an embodiment of the present invention, the number of dielectric grains per 10 μm in the dielectric layer 1 may be 15 or greater.

In order to measure the number of dielectric grains per 10 μm, the ceramic main body 10 may be cut in the lamination direction of the dielectric layer 1 and then the section as illustrated in FIG. 2 may be measured by a line dividing method.

In detail, the number of dielectric grains per 10 μm was determined by measuring the number of dielectric grains measured by using a scale bar of 10 μm.

In order to measure the number of dielectric grains, the number of dielectric grains may be measured by scanning the image of the section in the lengthwise direction of the ceramic main body 10 by the SEM.

For example, as shown in FIG. 2, with respect to a certain dielectric layer extracted from an image obtained by scanning the section in a lengthwise and thicknesswise (L-T) direction taken from a central portion in the widthwise (W) direction of the ceramic main body 10 by using the SEM, the number of dielectric grains at a certain point among thirty points at equidistant intervals in the lengthwise direction may be measured by using a 10 μm-scale bar.

Also, the certain point may be a central point among the thirty points at equidistant intervals in the lengthwise direction, and the number of dielectric grains at the central point may be measured by using the 10 μm-scale bar.

The thirty points at equidistant intervals may be determined at a capacitance formation portion which corresponds to an area in which the first and second inner electrodes 21 and 22 overlap.

With reference to FIG. 3, in the multi-layered ceramic capacitor according to an embodiment of the present invention, it is noted that the number of dielectric grains measured at one point of the section in the lengthwise and thicknesswise (L-T) direction taken from the central portion in the widthwise (W) direction of the ceramic main body 10 in FIG. 2 is 15 or greater.

The characteristics of the multi-layered ceramic capacitor in which the number of dielectric grains per 10 μm in the dielectric layer 1 is 15 or greater can be implemented by adjusting an average particle diameter of the dielectric grains.

In detail, according to an embodiment of the present invention, when an average particle diameter of the dielectric grains is defined as De, the average particle diameter De may satisfy the condition of De≦0.4 μm, in particular, 0.21 μm≦De≦0.4 μm.

In this manner, by adjusting the average particle diameter of the dielectric grains such that De≦0.4 μm, in particular, 0.21 μm≦De≦0.4 μm, a larger number of dielectric grains may be present per dielectric layer 1, thus improving withstand voltage.

Namely, the breakdown voltage per unit thickness of the dielectric layer 1 can be increased by the larger number of the dielectric grains per layer.

If the average particle diameter of the dielectric grains exceeds 0.4 μm, the average number of dielectric grains per layer would be reduced to lead to a reduction in withstand voltage characteristics allowing for the dielectric grains to withstand voltage, so the effect of withstand voltage improvement would not be great.

Also, if the average particle diameter of the dielectric grains is reduced to become smaller than 0.21 μm, the effect of the insulation characteristics would not be great.

The reason for this is because, when the particle diameter of the dielectric grains is reduced, although the average number of particles of the dielectric grains per layer will be increased, withstand voltage characteristics for one grain to withstand are reduced.

As described above, according to an embodiment of the present invention, the dielectric grains may be adjusted to have an average particle diameter De, namely, De≦0.4 μm, in particular, 0.21 μm≦De≦0.4 μm, such that the average thickness t_{d} of the dielectric layer 1 is 15 μm or greater and the number of dielectric grains per 10 μm is 15 or greater in the dielectric layer 1, whereby a relatively thick, uniform dielectric layer can be obtained to thus implement a high voltage multi-layered ceramic electronic component having excellent withstand voltage characteristics.

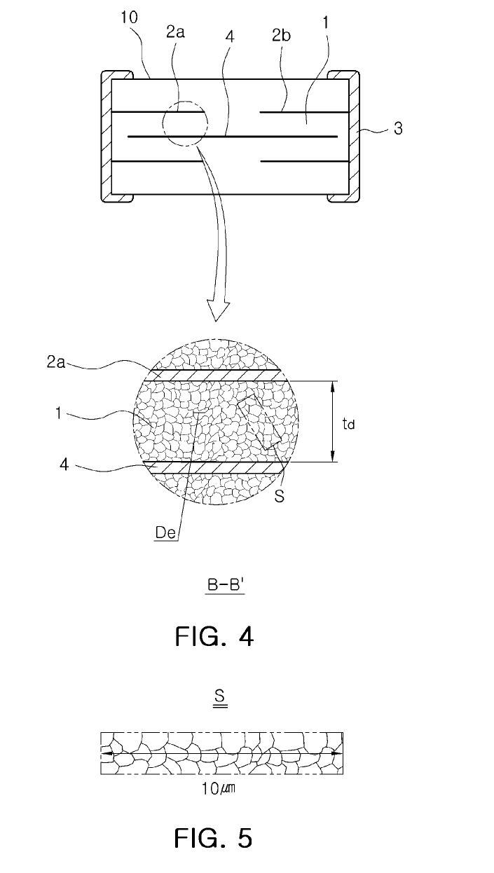

FIG. 4 is a cross-sectional view taken along line B-B′ in FIG. 1 according to another embodiment of the present invention, and FIG. 5 is an enlarged view of area ‘S’ in FIG. 4.

With reference to FIG. 4, the inner electrode layers may include first and second inner electrodes 2a and 2b having respective one ends exposed to respective end surfaces in the lengthwise direction of the ceramic main body 10 and at least one or more floating electrodes 4 forming an overlap area with the first and second inner electrodes 2a and 2b with the dielectric layer 1 interposed therebetween.

According to the present embodiment, since the at least one or more floating electrodes 4 forming an overlap area with the first and second inner electrodes 2a and 2b having the dielectric layer 1 interposed therebetween is provided, an electrical field concentration due to the reduction in the thickness of the dielectric layer can be prevented and required withstand voltage performance can be obtained.

With reference to FIG. 5, the multi-layered ceramic electronic component according to an embodiment of the present invention can obtain further improved withstand voltage performance by including the floating electrode 4 and the dielectric layer 1 having the thickness td of 15 μm or greater and adjusting the number of dielectric grains per 10 μm in the dielectric layer 1 such that it is 15 or greater.

Hereinafter, a multi-layered ceramic electronic component, in particular, a multi-layered ceramic capacitor, according to an embodiment of the present invention will be described, but the present invention is not limited thereto, and a description of overlap characteristics with those of the foregoing embodiment of the present invention will be omitted.

The multi-layered ceramic capacitor may include a plurality of the first and second inner electrodes 2a and 2b having respective one ends exposed to respective end surfaces in the lengthwise direction of the ceramic main body 10, and at least one or more floating electrodes 4 forming an overlap area with the first and second inner electrodes 2a and 2b with the dielectric layer 1 interposed therebetween.

Also, the first and second inner electrodes 2a and 2b and the floating electrode 4 may be alternately laminated between the dielectric layers 1.

The multi-layered ceramic capacitor may be configured to include a plurality of capacitor units in a serial connection owing to the at least one or more floating electrodes 4.

Accordingly, a multi-layered ceramic capacitor which is small but has large capacity can be implemented, and since withstand voltage can be increased per unit thickness of the dielectric layer, a high voltage multi-layered ceramic capacitor having excellent withstand voltage performance can also be implemented.

Meanwhile, according to an embodiment of the present invention, the multi-layered ceramic capacitor may include the floating electrodes 4, the thickness t_{d} of the dielectric layer 1 may be 15 μm or greater, and the number of dielectric grains per 10 μm in the dielectric layer 1 may be adjusted to be 15 or greater, thereby obtaining further improved withstand voltage performance.

Here, the thickness of the dielectric layer 1 and the number of dielectric grains per 10 μm are the same as those described above so, a description thereof will be omitted.

Because the number of the dielectric grains per 10 μm in the dielectric layer 1 is adjusted to be 15 or greater, withstand voltage per unit thickness of the dielectric can be further increased, and accordingly, withstand voltage performance can be further improved.

A multi-layered ceramic electronic component according to another embodiment of the present invention may include a ceramic main body including a plurality of dielectric layers laminated therein; and a plurality of inner electrode layers disposed to face each other, with each of the plurality of dielectric layers interposed therebetween in the ceramic main body, wherein when an average thickness of the dielectric layer 1 is defined as t_{d}, the average thickness t_{d} may be t_{d}≧15 μm, and the number of dielectric grains per 10 μm within the dielectric layer 1 may be 15 or greater.

The multi-layered ceramic electronic component according to the present embodiment is the same as the multi-layered ceramic electronic component according to the foregoing embodiment, except that the plurality of dielectric layers and the plurality of first and second inner electrode layers are laminated therein, so a repeated description will be omitted.

The inner electrode layers may include first and second inner electrodes alternately exposed to the respective opposed end surfaces of the ceramic main body.

Also, the inner electrode layers may include a plurality of first and second inner electrodes each having respective one ends exposed to the respective end surfaces in the lengthwise direction of the ceramic main body, and at least one or more floating electrodes forming an overlap area with the first and second inner electrodes 2a and 2b with the dielectric layer interposed therebetween.

When an average particle diameter of the dielectric grains is defined as De, the average particle diameter De may satisfy the condition of De≦0.4 μm, in particular, 0.21 μm≦De≦0.4 μm.

An average thickness of the dielectric layers may be an average thickness of the dielectric layer at the central portion in the section in the lengthwise and thickness (L-T) direction taken from the central portion in the widthwise (W) direction of the ceramic main body.

The measurement of the average value may extend to ten dielectric layers to measure an average thickness of the ten dielectric layers, to thereby further generalize the average thickness of the dielectric layer.

Meanwhile, as shown in FIG. 2, with respect to the central dielectric layer at the section in the lengthwise and thicknesswise (L-T) direction taken from the central portion in the widthwise (W) direction of the ceramic main body 10, the number of dielectric grains at a certain point among thirty points at equidistant intervals in the lengthwise direction may be measured by using a 10 μm-scale bar.

The present invention will be described in more detail through examples, but the present invention is not limited thereto.

The Example was manufactured to test improvements in withstand voltage characteristics and reliability of the multi-layered ceramic capacitor in which the first and second inner electrodes and the floating electrode 4 are alternately laminated between the dielectric layers, the thickness t_{d} of the dielectric layers is 15 μm or greater, and the number of dielectric grains per 10 μm within the dielectric layers is 15 or greater.

The multi-layered ceramic capacitor according to the Example was manufactured through the following operations.

First, slurry formed by including powder such as barium titanate (BaTiO₃) or the like was applied to a carrier film and dried to prepare a plurality of ceramic green sheets, thus forming the dielectric layer 1.

The thickness of the plurality of ceramic green sheets was set such that an average thickness of the dielectric layer after a firing operation was 15 μm.

An average thickness of the dielectric layer was designed to have a fine difference according to each example in consideration of shrinkage after the firing operation.

The average thickness of the dielectric layer was measured by using a measurement program after capturing an image of the dielectric layer by using an optical microscope.

Here, the average particle diameter De of the dielectric grains was adjusted to be 0.4 μm or smaller. In detail, in Examples 1 to 3, the average particle diameter De of the dielectric grains was adjusted to be 0.40 μm, 0.32 μm, and 0.21 μm, respectively.

Next, conductive paste for inner electrodes having an average nickel particle size of 0.05 μm to 0.2 μm was prepared.

The conductive paste for inner electrodes was applied to the green sheet through screen printing to form inner electrodes, and 50 layers were laminated to form a lamination body.

Here, the inner electrodes were manufactured such that a plurality of first and second inner electrodes 2a and 2b having respective one ends exposed to the respective end surfaces in the lengthwise direction of the ceramic main body 10 and at least one or more floating electrodes 4 forming an overlap area S with the first and second inner electrodes 2a and 2b were alternately formed.

Thereafter, the lamination body was compressed and cut to generate a chip having a 3216 standard size, and the chip was fired at a temperature of 1050└ to 1200└ under a reduction atmosphere of 0.1% of H₂ or less.

Then, the resultant structure underwent processes such as an external electrode formation process, a plating process, or the like, so as to be a multi-layered ceramic capacitor.

Meanwhile, Comparative Example 1 was manufactured according to the same method except that the average particle diameter of dielectric grains and the number of dielectric grains per 10 μm within the dielectric layer were different in comparison to the Example.

Also, Comparative Examples 2 and 3 were manufactured according to the same method, except that the average thickness of the dielectric layer was 12.0 μm and 10.0 μm, lower than 15 μm, respectively, after a firing operation, in comparison to the Example.

Table 1 below shows the comparison of the average thickness of the dielectric layer after a firing operation, the average particle diameter of the dielectric grains, the average breakdown voltage V according to the number of dielectric grains per 10 μm in the dielectric layer, and withstand voltage V per dielectric grain.

TABLE 1

| | Average | Average | | Average | |
|---|---|---|---|---|---|
| | particle | thickness | | dielectric | With- |
| | diameter | (t_{d}) of | Number of | break- | stand |
| | (De) of | dielectric | dielectric | down | voltage |
| | dielectric | layer after | grains per | voltage | (V) per |
| No. | grain (μm) | firing (μm) | 10 μm | (V) | grain |
| Experimental | 0.52 | 15.0 | 11 | 626 | 39.6 |
| Example 1 | | | | | |
| Comparative | 0.40 | 12.0 | 15 | 849 | 47.2 |
| Example 2 | | | | | |
| Comparative | 0.40 | 10.0 | 15 | 694 | 46.3 |
| Example 3 | | | | | |

With reference to Table 1, Experimental Example 1 shows a case in which the average thickness of the dielectric layer was 15 μm, and it is noted that when the average particle diameter of the dielectric grains and the number of dielectric grains per 10 μm exceed the range of the numerical values of the present invention, the breakdown voltage and withstand voltage are problematic.

Meanwhile, Comparative Examples 2 and 3 show cases in which the average thickness of the dielectric layer was smaller than 15 μm, and it is noted that although the average particle diameter of the dielectric grains and the number of dielectric grains per 10 μm exceeded the range of the numerical values of the present invention, there were no defects with breakdown voltage and withstand voltage.

Thus, it is noted that the multi-layered ceramic electronic component according to an embodiment of the present invention has an effect in terms of breakdown voltage and withstand voltage when the average thickness t_{d} after the dielectric layer 1 is fired is 15 μm or greater, by explanation to be below provided.

Table 2 below shows a comparison of the average particle diameter of the dielectric grains, the average breakdown voltage V according to the number of dielectric grains per 10 μm in the dielectric layer, and withstand voltage V per dielectric grain, when the average thickness of the dielectric layer after the firing operation was 15 μm.

The breakdown voltage (BDV) characteristics were evaluated while applying a DC voltage at a rate of 10V/sec.

TABLE 2

| | | Average | | | |
|---|---|---|---|---|---|
| | | thickness | | | |
| | Average | of | | | |
| | particle | dielectric | | Average | With- |
| | diameter | layer | Number of | dielectric | stand |
| | (De) of | after | dielectric | breakdown | voltage |
| | dielectric | firing | grains per | voltage | (V) per |
| No. | grain (μm) | (t_{d}) | 10 μm | (V) | grain |
| Comparative | 0.52 | 15.0 | 11 | 626 | 39.6 |
| Example 1 | | | | | |
| Example 1 | 0.40 | 15.0 | 15 | 781 | 42.7 |
| Example 2 | 0.32 | 15.0 | 16 | 937 | 38.9 |
| Example 3 | 0.21 | 15.0 | 20 | 965 | 34.6 |

As noted from Table 2, as the average diameter De of the dielectric grains was reduced, the average number of dielectric particles of the dielectric layer was increased, and accordingly, the average breakdown voltage was drastically increased.

Namely, in the case of Comparative Example 1 in which the average particle diameter De of the dielectric grain exceeded 0.5 μm, the average breakdown voltage was low as compared with Examples 1 through 3, each having an average particle diameter of 0.5 μm or smaller.

Meanwhile, it is noted that the insulation characteristics of Examples 1 through 3 in which the numbers of dielectric grains per 10 μm in the dielectric layer were 15, 16, and 20, respectively, superior to those of Comparative Example 1 in which the number of dielectric grains per 10 μm in the dielectric layer was 11.

In the case of Example 3, the average particle diameter of the dielectric grains was 0.21 μm, whose effect of increasing the average breakdown voltage was not relatively great in comparison to Example 2.

The reason is determined to be that when the particle diameter of the dielectric grains was reduced, the average number of particles of the dielectric grains per layer was increased, but the withstand voltage characteristics which each grain can withstand are reduced.

Thus, although the average particle diameter of the dielectric grains was further reduced to become smaller than 0.21 μm, the effect of the insulation characteristics was not great.

As a result, by having at least one or more floating electrodes forming an overlap area with the first and second inner electrodes with the dielectric layer interposed therebetween, an electrical field concentration due to the reduction in the thickness of the dielectric layer may be prevented and withstand voltage characteristics may be improved.

In addition, the thickness t_{d} of the dielectric layer is 15 μm or greater and the average particle diameter De of the dielectric grains is 0.4 μm or smaller, and in this case, when the number of the dielectric grains per 10 μm in the dielectric layer is 15 or greater, withstand voltage characteristics may be further improved and the reliability may also be improved.

According to an embodiment of the present invention, the high voltage multi-layered ceramic capacitor can be implemented to be small and have high capacity, and reliability thereof can be improved owing to the excellent withstand voltage characteristics.

As set forth above, according to embodiments of the invention, since a uniform, thick dielectric layer can be obtained with fine dielectric powder, a high voltage multi-layered ceramic electronic component having excellent withstand voltage characteristics can be implemented.

While the present invention has been shown and described in connection with the embodiments, it will be apparent to those skilled in the art that modifications and variations can be made without departing from the spirit and scope of the invention as defined by the appended claims.

What is claimed is:

1. A multi-layered ceramic electronic component, the component comprising:
a ceramic main body including a dielectric layer; and
inner electrode layers disposed to face each other, with the dielectric layer interposed therebetween, in the ceramic main body,
wherein when an average thickness of the dielectric layer is defined as t_{d}, the average thickness t_{d} is t_{d}≧15 μm, and the number of dielectric grains per 10 μm within the dielectric layer is 15 or greater.

2. The component of claim 1, wherein the inner electrode layers include first and second inner electrodes each having one ends thereof alternately exposed to respective opposed end surfaces of the ceramic main body.

3. The component of claim 1, wherein the inner electrode layers include a plurality of first and second inner electrodes having respective one ends exposed to respective end surfaces in a lengthwise direction of the ceramic main body, and at least one or more floating electrodes forming an overlap area with the first and second inner electrodes, with the dielectric layer interposed therebetween.

4. The component of claim 1, wherein when an average particle diameter of the dielectric grains is defined as De, the average particle diameter De satisfies the condition of De≦0.4 μm.

5. The component of claim 1, wherein when the average particle diameter of the dielectric grains is defined as De, the average particle diameter De satisfies the condition of 0.21 μm≦De≦0.4 μm.

6. The component of claim 1, wherein the average thickness of the dielectric layer is an average thickness of the dielectric layer in the section in a lengthwise and thicknesswise direction taken from a central portion in the widthwise direction of the ceramic main body.

7. A multi-layered ceramic electronic component, the component comprising:
a ceramic main body including a plurality of dielectric layers laminated therein; and
a plurality of inner electrode layers disposed to face each other, with each of the plurality of dielectric layers interposed therebetween in the ceramic main body,
wherein when an average thickness of the dielectric layer is defined as t_{d}, the average thickness t_{d} is t_{d}≧15 μm, and the number of dielectric grains per 10 μm within the dielectric layer is 15 or greater.

8. The component of claim 7, wherein the inner electrode layers include first and second inner electrodes each having one ends thereof alternately exposed to respective opposed end surfaces of the ceramic main body.

9. The component of claim 7, wherein the inner electrode layers include a plurality of first and second inner electrodes each having respective one ends exposed to respective end surfaces in a lengthwise direction of the ceramic main body, and at least one or more floating electrodes forming an overlap area with the first and second inner electrodes, with the dielectric layer interposed therebetween, and the first and second inner electrodes and the floating electrodes are alternately laminated between the dielectric electrodes.

10. The component of claim 7, wherein when an average particle diameter of the dielectric grains is defined as De, the average particle diameter De satisfies the condition of De≦0.4 μm.

11. The component of claim 7, wherein when the average particle diameter of the dielectric grains is defined as De, the average particle diameter De satisfies the condition of 0.21 μm≦De≦0.4 μm.

12. The component of claim 7, wherein the average thickness of the dielectric layer is an average thickness of the dielectric layer at a central portion in the section in a lengthwise and thicknesswise direction taken from the central portion in the widthwise direction of the ceramic main body.
